(19) United States
(12) Patent Application Publication
(10) Pub. No.: US 2020/0259417 A1
(43) Pub. Date: Aug. 13, 2020

(54) TOPOLOGY OF A DC-DC CONVERTER

(71) Applicant: Vitesco Technologies Germany GmbH, HANNOVER (DE)

(72) Inventor: OMAR VIT, NUERNBERG (DE)

(21) Appl. No.: 16/651,600

(22) PCT Filed: Oct. 10, 2018
(86) PCT No.: PCT/EP2018/077647

§ 371 Date: Mar. 27, 2020

(30) Foreign Application Priority Data
Oct. 13, 2017 (DE) 10 2017 218 364

(51) Int. Cl. H02M 3/158; H02M 1/00

(52) U.S. Cl. CPC H02M 3/1582; H02M 2001/009; H02M 1/00

(57) ABSTRACT

A DC-DC converter includes an electrical coil which is connected to a DC voltage source and subsequently or additionally to an output segment in an alternating manner by electronic switches. The DC-DC converter is improved by providing a DC voltage controller having a plurality of inputs, a plurality of outputs, a plurality of input switches, a plurality of outputs switches, and two system switches. The output switches are connected to the input switches by the controller which is constructed as a buck-boost controller, and the inputs and the outputs are coupled to switching units for a timing control.

The invention relates to a DC-DC converter having an electrical coil that is alternately connected to a DC voltage source and subsequently or additionally connected to an output segment by means of electronic switches.

DC-DC converters are understood to mean electrical circuits that convert the DC voltages supplied to them on the input side into DC voltages that differ therefrom on the output side. Normally, a DC-DC converter has an electrical coil for storing electrical energy that is alternately connected to a DC voltage source producing an input voltage, and is charged in the process, and subsequently connected to an output segment, and is at least partially discharged via the output segment (CCM mode) in the process, by means of an electronic switch, so that an output voltage different than the input voltage can be tapped off from the output segment.

EP 2 881 831 A1 discloses a DC-DC converter that has a coil, an electronic input switch for connecting the input side of the coil to a connection pole of a DC voltage source, at least two output segments that are each connectable to the output side of the coil via an electronic segment switch and from each of which an output voltage can be tapped off, and a control unit for time-dependent actuation of the input switch and the segment switches.

The invention is based on the object of providing an improved DC-DC converter.

The invention is achieved by means of a DC-DC converter that has the features specified in claim 1.

The subclaims relate to advantageous configurations.

The DC-DC converter according to the invention has multiple inputs, multiple outputs, multiple input switches, multiple output switches and two system switches. The output switches are connected to the input switches via a buck-boost controller. The inputs and the outputs are coupled to switching units for time control.

The DC-DC converter allows a high level of flexibility in the source management. Just one coil can be used to produce multiple voltages and to connect multiple inputs and multiple outputs to one another in any manner.

One advantageous configuration provides for the buck-boost controller to contain mirrored pairs of MOSFETs (metal oxide semiconductor field effect transistors) to ensure bidirectional switching.

This allows any inputs and outputs to be connected to one another directly.

The invention is explained in more detail below with reference to an exemplary embodiment.

In the associated drawing:

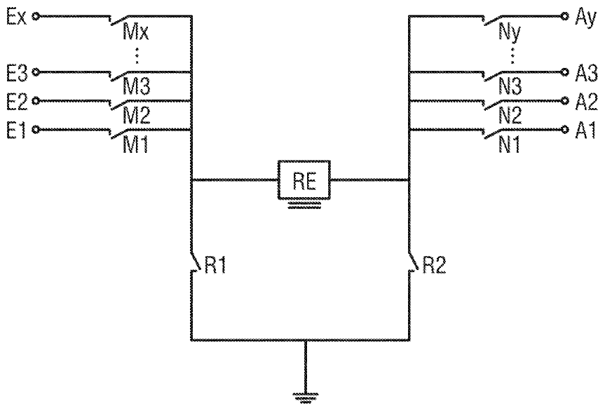

FIG. 1 shows a schematic depiction of the circuit of the DC-DC converter.

The circuit diagram of the exemplary embodiment reveals that the inputs E1, E2, E3, . . . , Ex are each connected to the input of the controller RE in the form of a buck-boost controller and to the first system switch R1 via input switches M1, M2, M3, . . . , Mx. The output of the controller RE is connected to the second system switch R2 and to the output switches N1, N2, N3, . . . , Ny. Outputs A1, A2, A3, . . . , Ay are connected via the output switches N1, N2, N3, . . . , Ny. The circuit is grounded via the system switches R1 and R2. The controller RE contains mirrored MOSFET pairs in order to ensure bidirectional switching, said MOSFET pairs being used to control the inputs E1, E2, E3, . . . , Ex and the outputs A1, A2, A3, . . . , Ay.

This arrangement can be used to directly connect each of any inputs E1, E2, E3, . . . , Ex and outputs A1, A2, A3, . . . , Ay to one another each time and also inputs E1, E2, E3, . . . , Ex to outputs A1, A2, A3, . . . , Ay. For example, the following configuration is possible: a 12V source is connected to the input E1 and is connected to the output A1. The input E2 is connected to a 24V source and is connected to the output A2. It is thus possible for the 24V source to charge the 12V source, and vice versa.

### LIST OF REFERENCE SIGNS

E1, E2, E3, . . . , Ex inputs
A1, A2, A3, . . . , Ay outputs
M1, M2, M3, . . . , Mx input switches
N1, N2, N3, . . . , Ny output switches
R1, R2 system switches
RE controller

1-2. (canceled)

3. A DC-DC converter having an electrical coil alternately connected to a DC voltage source and subsequently or additionally connected to an output segment by electronic switches, the DC-DC converter, comprising:
a plurality of inputs;
a plurality of outputs;
a plurality of input switches;
a plurality of output switches;
two system switches; and
a buck-boost controller connecting said output switches to said input switches, said buck-boost controller having switching units coupling said inputs and said outputs for time control.

4. The DC-DC converter according to claim 3, wherein said switching units contain mirrored MOSFET pairs to ensure bidirectional switching.
